(19) United States
(12) Patent Application Publication
(10) Pub. No.: US 2022/0074343 A1
(43) Pub. Date: Mar. 10, 2022

(54) TURBOCHARGER WITH TWO COMPRESSORS DRIVEN BY A SINGLE TURBINE

(71) Applicant: Bullseye Power, LLC, Muskegon, MI (US)

(72) Inventor: David M. Hall, Muskegon, MI (US)

(73) Assignee: Bullseye Power, LLC, Muskegon, MI (US)

(21) Appl. No.: 17/017,181

(22) Filed: Sep. 10, 2020

(51) Int. Cl. F02B 37/007

(52) U.S. Cl. CPC F02B 37/007

(57) ABSTRACT

A turbocharger for an internal combustion engine includes two compressors, each having a compressor wheel mounted on opposite ends of a common shaft, and a turbine having a turbine wheel mounted on the same shaft as the compressor wheel and between the compressor wheels, to reduce turbo-lag, while providing a reliable and robust structural design.

### FIELD OF THE DISCLOSURE

This disclosure relates to turbochargers for internal combustion engines.

### BACKGROUND OF THE DISCLOSURE

Turbochargers are used for extracting energy from the exhaust gas produced during internal combustion to drive a compressor to boost the pressure of the air supplied to the internal combustion engine. Conventional turbochargers exhibit a lag between the time that the throttle is opened to the time that the boost (increase in intake air pressure) reaches the engine. While part of the lag can be attributed to the time it takes for compressed air to be conveyed from the compressor outlet to the air intake manifold, a larger contributor is the time it takes to impart inertia to the turbine wheel and compressor wheel. It is possible to reduce lag by using a smaller turbocharger. However, a smaller turbocharger also produces less added power. Other solutions involve relatively complex structures including variable geometry turbochargers, twin-scroll turbochargers, and sequential turbochargers.

### SUMMARY OF THE DISCLOSURE

Disclosed is a turbocharger exhibiting reduced lag while employing a relatively simple structure that is reliable and robust. The turbocharger employs two compressors driven by a turbine disposed between the compressors. More specifically, each compressor has a compressor wheel, wherein the compressor wheels are fixed on opposite ends of a rotatable shaft, and the turbine wheel is also fixed on the rotatable shaft between the compressor wheels. This arrangement is able to provide a given boost with less torque by using two smaller compressor wheels rather than a single larger compressor wheel.

### BRIEF DESCRIPTION OF THE DRAWINGS

FIG. 1 is a perspective view of the disclosed turbocharger with the turbine housing removed to show the turbine wheel disposed between two compressors.

FIG. 2 is a schematic depiction of a turbocharged engine system employing a turbocharger in accordance with this disclosure.

FIG. 3 is a perspective view of a compressor as shown in FIG. 1, with a portion of one of the compressor housings broken away to show the volute and compressor wheel.

### DETAILED DESCRIPTION

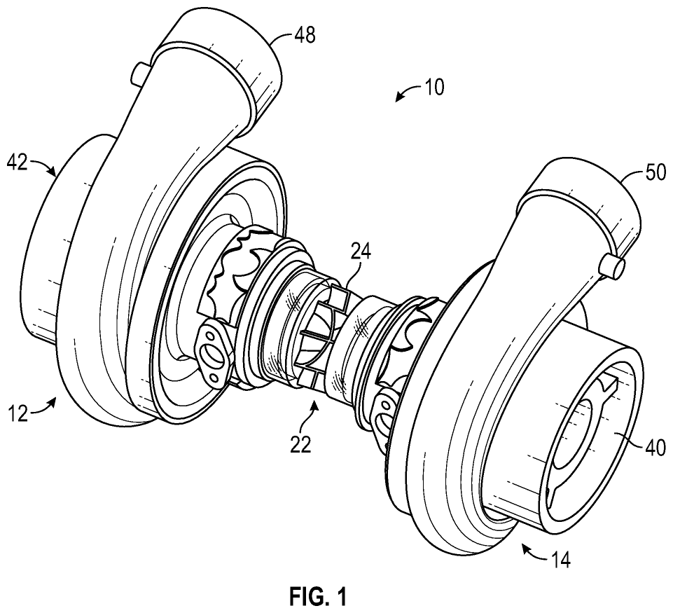

A turbocharger 10 in accordance with this disclosure is shown in FIG. 1. Turbocharger 10 includes a first compressor 12 having a first compressor wheel 14 fixed on a first end of a rotatable shaft 16, a second compressor 18 having a second compressor wheel 20 fixed on a second end of the shaft 16 opposite the first end, and a turbine 22 having a turbine wheel 24 fixed on shaft 16 between first compressor wheel 14 and second compressor wheel 20. In this arrangement, all wheels (14, 18 and 24) rotate together on shaft 16 at the same rotational speed.

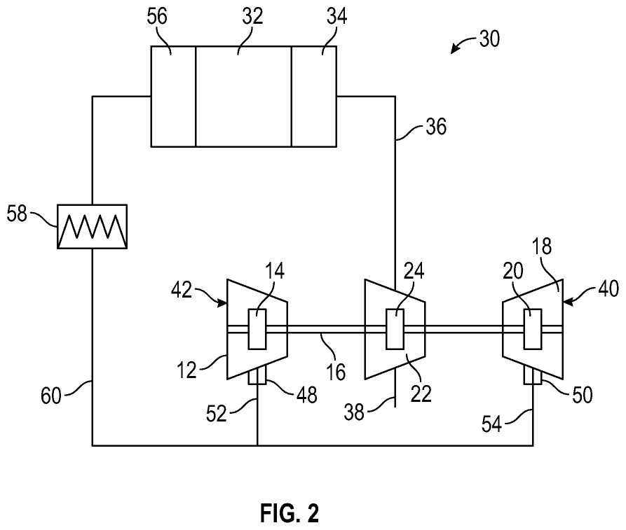

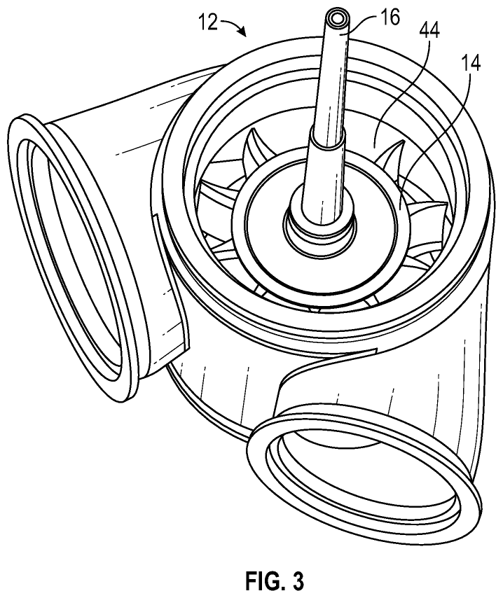

A turbocharged internal combustion engine system 30 is shown in FIG. 2. System 30 includes, in addition to turbocharger 10, an internal combustion engine 32 (e.g., diesel or gasoline) having associated therewith an exhaust manifold 34 and an exhaust conduit 36 for conveying combustion exhaust gases to drive turbine wheel 24. Exhaust conduit 38 conveys the exhaust gases to an exhaust treatment system (e.g., catalytic converter, muffler, etc.). Compressors 12 and 18 include air inlets 40, 42 for drawing ambient air into the compressor volute 44 (FIG. 3).

Compressors 12 and 18 also include compressed air outlets and compressed air conduits 52, 54 for conveying compressed air from the compressors to an air intake manifold 56 associated with engine 32. As is typically the case, system 30 can be provided with an intercooler 58 for reducing the temperature of the compressed air before it enters manifold 56 and engine 32.

In the illustrated embodiment, air inlet 42 for first compressor 12 is parallel with the air inlet 40 for second compressor 14, and air outlet of first compressor 12 is parallel with air outlet 50 of second compressor 14. The exhaust gases are split between the two compressors, rather than flowing through a first compressor arranged in series with the first compressor. Also, in the illustrated embodiments, compressor 12 has a housing and volute 44 that is substantially a mirror image of housing and volute 46 of compressor 14.

In the illustrated embodiment, conduit 60 is provided for combining and conveying compressed air from the first compressor and the second compressor to the air intake manifold.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

What is claimed is:

1. A turbocharger comprising:
a first compressor having a first compressor wheel fixed on a first end of a rotatable shaft;
a second compressor having a second compressor wheel fixed on a second end of the rotatable shaft; and
a turbine having a turbine wheel fixed on the rotatable shaft between the first compressor wheel and the second compressor wheel.

2. The turbocharger of claim 1, further comprising an air inlet for the first compressor and an air inlet for the second compressor, wherein the air inlet for the first compressor is parallel with the air inlet for the second compressor.

3. The turbocharger of claim 1, further comprising an air outlet for the first compressor and an air outlet for the second compressor, wherein the air outlet for the first compressor is parallel with the air outlet for the second outlet.

4. The turbocharger of claim 1, wherein the first compressor has a first housing defining a first volute and the second compressor has a second housing defining a second volute, wherein the first and second volutes are substantially mirror images with respect to a plane bisecting the axial direction of the shaft.

5. The turbocharger of claim 1, wherein the first compressor wheel is substantially a mirror image of the second compressor wheel with respect to a plane bisecting the axial direction of the shaft.

6. The turbocharger of claim 2, further comprising an air outlet for the first compressor and an air outlet for the second compressor, wherein the air outlet for the first compressor is parallel with the air outlet for the second outlet.

7. The turbocharger of claim 6, wherein the first compressor has a first housing defining a first volute and the second compressor has a second housing defining a second volute, wherein the first and second volutes are substantially mirror images with respect to a plane bisecting the axial direction of the shaft.

8. The turbocharger of claim 7, wherein the first compressor wheel is substantially a mirror image of the second compressor wheel with respect to a plane bisecting the axial direction of the shaft.

9. A turbocharged internal combustion engine system, comprising:
an internal combustion engine having an air intake manifold and an exhaust manifold;
a turbine;
an exhaust conduit for conveying exhaust gases from the exhaust manifold to the turbine;
a first compressor having a first compressor wheel;
a second compressor having a second compressor wheel; and
wherein the first compressor wheel is fixed to one end of a rotatable shaft, the second turbine wheel is fixed to a second end of the rotatable shaft, and the turbine includes a turbine wheel fixed to a rotatable shaft between the first compressor wheel and the second compressor wheel.

10. The system of claim 9, further comprising conduit for combining and conveying compressed air from the first compressor and the second compressor to the air intake manifold.

11. The system of claim 9, further comprising an air inlet for the first compressor and an air inlet for the second compressor, wherein the air inlet for the first compressor is parallel with the air inlet for the second compressor.

12. The system of claim 9, further comprising an air outlet for the first compressor and an air outlet for the second compressor, wherein the air outlet for the first compressor is parallel with the air outlet for the second outlet.

13. The system of claim 9, wherein the first compressor has a first housing defining a first volute and the second compressor has a second housing defining a second volute, wherein the first and second volutes are substantially mirror images with respect to a plane bisecting the axial direction of the shaft.

14. The system of claim 9, wherein the first compressor wheel is substantially a mirror image of the second compressor wheel with respect to a plane bisecting the axial direction of the shaft.

15. The system of claim 12, further comprising an air outlet for the first compressor and an air outlet for the second compressor, wherein the air outlet for the first compressor is parallel with the air outlet for the second outlet.

16. The system of claim 13, wherein the first compressor has a first housing defining a first volute and the second compressor has a second housing defining a second volute, wherein the first and second volutes are substantially mirror images with respect to a plane bisecting the axial direction of the shaft.

17. The system of claim 14, wherein the first compressor wheel is substantially a mirror image of the second compressor wheel with respect to a plane bisecting the axial direction of the shaft.

18. The system of claim 17, further comprising conduit for combining and conveying compressed air from the first compressor and the second compressor to the air intake manifold.
